(19) United States
(12) Patent Application Publication
(10) Pub. No.: US 2014/0129403 A1
(43) Pub. Date: May 8, 2014

(54) SYSTEM AND METHOD TO CREATE AN INVESTMENT EXCHANGE BY REALLOCATION OF YIELDS OF FINANCIAL SECURITIES

(71) Applicants: Stephen Edward Rossi, Naples, FL (US); Durham Russell Maples, Camden, SC (US)

(72) Inventors: Stephen Edward Rossi, Naples, FL (US); Durham Russell Maples, Camden, SC (US)

(21) Appl. No.: 13/669,442

(22) Filed: Nov. 6, 2012

(51) Int. Cl. G06Q 40/04

(52) U.S. Cl. CPC G06Q 40/04
USPC 705/37

(57) ABSTRACT

An investment process transacted by means of an Investment Exchange that is powered by a proprietary reallocation algorithm that reallocates the cash flows on an issuer's private placement Investment Unit offering and works by internally re-generating, redistributing and rebalancing the various securities comprising the Investment Unit with a means of monetizing the income stream wherein the cash flows of the securities comprising the Investment Unit are reallocated, repackaged, matched and hedged in a cash-settled capital raising process to provide superior returns to primary and secondary investors and a relatively low amount of stock dilution and no stock price discount to existing shareholders of an issuer of equity securities.

### CROSS-REFERENCE TO RELATED APPLICATIONS

This application claims priority to provisional application No. U.S. 61/556,183, filed on 5 Nov. 2011, entitled “System and Method To Create an Investment Exchange By Reallocation of Yields of Financial Securities.”

### U.S. PATENT DOCUMENTS

U.S. Pat. No. 7,096,195 B1 Aug. 22, 2006 Maples 705/36
Ser. No. 12/005,595 Dec. 27, 2007 Maples 3691

### FOREIGN PATENT DOCUMENTS

PCT/US99/17242 Jul. 29, 1999 Maples G06F 17/60

### STATEMENT REGARDING FEDERALLY SPONSORED RESEARCH OR DEVELOPMENT

Not Applicable

### OTHER PUBLICATIONS

### Internal Revenue

U.S. Tax Code-Sec. 1273(c) (2)—7/18/1984

Section 1273 (c)(2) of the Internal Revenue Code of 1986

Section 163(1) of the Internal Revenue Code of 1986

IRS Revenue Ruling 2003-97

### Statutes

Federal Reserve Regulation DD: Section 230.8

Securities Act of 1933: Section 2(a)(1); Regulation D; Section 3(a); Part 16

Investment Company Act of 1940: Rule 102 of Regulation M; Section 3(c)(1); Section 3(c)(7)

Exchange Act of 1934: Section 12(g)(1)

Investment Advisers Act of 1940, Section 203(a); Section 202(a)(11)

National Securities Markets Improvement Act: amended Section 18

Base1 III Proposal

Dodd-Frank Wall Street Reform and Consumer Protection Act: Section 210(c)(3)(D)—Measure of damages for repudiation or disaffirmance of debt obligation

12 U.S.C. §24 “Seventh”: Investments Securities Letter No. 32 reprinted in [1989-1990 Transfer Binder] Fed. Banking L. Rep. (CCH) ¶83,038 (Dec. 2, 1988)

12 U.S.C. §1831f(g)(1)(A) and 12 U.S.C. §1831f(g)(2)(I)

12 U.S.C. §84

12 C.F.R. 16 (“Part 16”)

12 C.F.R. §337.6(a)(2)

12 C.F.R. §337.6(a)(5)(i)(A) and 12 C.F.R. §337.6(a)(5)(ii)(I)

12 C.F.R. §32

12 C.F.R. Part 1

12 C.F.R. §5.46(b) and §5.46(g)

Chapter 31 of Title 31 of the United States Code

### Securities and Exchange Commissioin

SEC No-action letter to E.F. Hutton & Co., Inc. (pub. avail. Mar. 28, 1985)

SEC No-action letter in Apfel & Co., Inc. (pub. avail. Jul. 18, 1991)

SEC No-action letter to UnumProvident Corporation (Feb. 3, 2006)

SEC No-action letter to TECO Energy, Inc. (Oct. 8, 2004)

SEC No-action letter to The Williams Companies, Inc. (Nov. 5, 2004)

SEC No-action letter to Cendant Corporation (May 2004)

SEC No-action letter to TXU Corp. (August 2004)

SEC No-action letter to Affiliated Managers Group (August 2004)

SEC No-action letter to Zenkyoren Asset Management of America Inc., (Jun. 30, 2011)

SEC No-action letter to Lockheed Martin Investment Management Co., (Jun. 5, 2006)

SEC No-action letter to BankAmerica Capital Corp., (Apr. 27, 1978)

SEC No-action letter to CSX Financial Management, Inc., (Jun. 23, 1999)

### Federal Deposit Insurance Corporation

Federal Deposit Insurance Act at 12 U.S.C. 1813(1)

Federal Deposit Insurance Act Section 3(1)

FDIC's regulations (12 C.F.R. §330.11)

FDIC's regulations (12 C.F.R. §330.4)

FDIC's regulations (12 C.F.R. §337.6)

FDIC Advisory Opinion No. 94-13 (Mar. 11, 1994)

FDIC Advisory Opinion No. 90-21 (May 29, 1990)

FDIC Advisory Opinion No. 94-13 (Mar. 11, 1994)

FDIC Advisory Opinion No. 94-39 (Aug. 17, 1994)

FDIC Financial Institution Letter, FIL-25-2012

### Cases

National Bank v. Johnson, 104 U.S. 271 (1881)

Steward v. Atlantic National Bank, 27 F.2d 224, 228 (9th Cir. 1928)

Morris v. Third National Bank, 142 F. 25 (8th Cir. 1905)

Danforth v. National State Bank of Elizabeth, 48 F.271 (3d Cir. 1891)

Gary Plastics Packaging v. Merrill Lynch, Pierce, Fenner, & Smith Inc., 756 F.2d 230 (2d

Marine Bank v. Weaver, 455 U.S. 551 (1982)

### Office of Comptroller of Currency

OCC Conditional Approval No. 262

OCC Interpretive Letter No. 833 (Jul. 8, 1998)

OCC Interpretive Letter No. 834, (Jul. 8, 1998)

OCC Interpretive Letter No. 600 (Jul. 31, 1992)

OCC Interpretive Letter No. 182 (Mar. 10, 1981)

OCC Interpretive Letter No. 579 (Mar. 24, 1992)

OCC Interpretive Letter No. 778 (Mar. 20, 1997)

OCC Interpretive Letter No. 981 (Aug. 14, 2003)

OCC Interpretive Letter No. 385 (Jun. 19, 1987)

OCC Corporate Decision No. 2000-02 (Feb. 25, 2000)

LinkedIn IPO Soars, Feeding Web Boom

Barclay's capital raising-the real cost of Bob Diamond.

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to the field of private equity investing, banking regulations, tax law, stock exchanges, securities exchanges, securities auctions and securities law.

2. Description of the Related Art

There is currently a great demand and activity in the investment and financial community related to issuers of debt and equity for general business activities and operations for a company, including regulatory capital issuances of financial institutions but they suffer from certain drawbacks such as the lack of an active trading market because of yield returns, risk and a variety of other investor criteria as defined by the Securities Act of 1933.

There is also currently also a great demand and interest from both accredited and non-accredited investors for the universe of higher yielding securities, including hybrid certificates of deposit whose investor needs and appetites are not being met due to the unattractive returns being offered. The present invention provides such a qualified or nonqualified investor a financial security with superior returns, which is initially embedded as part of an investment unit and is subsequently separated from the investment unit and exchanged with a financial security that produces superior returns.

The financial markets worldwide are always looking for new forms of financial securities and methods and systems that can raise additional money for corporations or other financial entities and are attractive to investors. Companies have financial product engineers who are constantly looking for better structures for securities in order to raise more money for corporations, provide investment products attractive and suitable for investors, both non-institutional and institutional, and provide fees to investment banks and other financial intermediaries. The various financial security offerings must comply and operate within applicable tax, securities and other laws and regulations.

Corporations have difficulty with having to sell debt, equity and other financial securities and financial assets in their corporation at a discount price. Corporations often find it necessary to sell a large amount of stock (or other financial securities and assets) sometimes in a private placement or with an investment bank or financial intermediary that in turn sells the stock to clients or in the open market on behalf of the corporation. These investors want to be protected from a price drop that can happen before the investors can resell their investments in the stock of a corporation at a profit. The investors often require the corporation to sell their stock at a discount of at least 25% and sometimes as much as 40%. This means that the corporation has to sell more stock than they actually get the money for, causing dilution spread among the shareholder base. This will lead to further stock dilution of the corporations whenever they try selling additional stock later.

Corporations have used instruments to attempt to sell stock, before but none have sought to solve the discount problem. The patent application Maples U.S. Ser. No. 12/005,595 does not disclose or mention such a solution. The patent Maples U.S. Pat. No. 7,096,196 and the PCT Maples PCT/US99/17252/do not raise any new money for the corporation and thus, does not solve the discount problem either. The Hybrid Income Term Securities (HITS) also do not disclose a solution to the discount problem and these “HITS” require a Trust that is both cumbersome and costly.

Stock dilution is the devaluation of the individual stock value based on more shares being issued without a corresponding increase in the corporation's net value. When the cash or asset added to the corporation is less than the value of the shares issued, then the individual stock value is decreased and this leads to suppressed market capitalizations. This decreases the value of the shares owned by the existing stockholders and decreases the share value in the future should the corporation need to raise additional capital or equity. The cycle repeats itself and the corporation is back to the same predicament of trying to sell new stock at another 25% to 40% discount and this only makes the problem worse. This it is like a government that prints too much of its own currency and causes the currency to become devalued. More currency chasing the same amount goods devalues the currency.

The stock of a corporation is a form of currency for that corporation. The aggregate amount of the stock of a corporation is the market capitalization. For banks in particular, the stock represents more than the bank's own currency, it is also the bank's regulatory capital. Banks are heavily regulated by the government and capital requirements are part of these regulations. Government regulations require a bank to hold certain types of capital to provide protection against unexpected losses.

The two main types of bank capital that are relevant to this discussion are Tier-1 and Tier-2 capital. Tier-1 capital is the core measure of a bank's financial strength from a regulators point of view. It is composed of core capital, which consists primarily of common stock and disclosed reserves (or related earnings) but may include non-redeemable (perpetual) non-cumulative convertible preferred stock (the “Convertible Preferred Stock”).

Whenever a bank sells stock and is forced to sell at a discount, the bank is hurt and impaired not only in that the bank receives less money for the stock issued, but the bank receives less Tier-1 capital as well. The bank gets credit under regulations for Tier-1 capital based only for actual cash received for the stock. So if the bank sells $100 million of stock for $75 million (a 25% discount) the bank, by regulation, books only $75 million as Tier-1 capital. Thus, a bank is impaired in two ways by having to sell their stock at a discount.

The banking industry as a whole is in crisis and having great difficulty in raising capital primarily because they are unable to sell stock, even with a substantial discount to investors that shun the industry. Banks are being taken into receivership in large numbers because the banks are undercapitalized. According to the Dodd-Frank Act, banks do not have adequate Tier-1 and Tier-2 capital ratios, and are primarily undercapitalized in terms of Tier-1. The current economic environment is making it even more difficult for a corporation or a bank to sell stock to raise capital. For banks, this is without question a down market in the midst of the subprime debacle and the home foreclosures. The banks keep experiencing these unexpected losses and need Tier-1 capital solutions. Consequently, the banking sector stocks have suffered large losses in the October 2011 stock market downturn.

The minimum Tier-1 capital ratio for a bank to be adequately capitalized is 4% of ownership equity but investors generally require a ratio of 10%. That means that at a 4% Tier-1 ratio, the bank must have $1 of Tier-1 capital for every $25 of assets on the banks balance sheet. Assets to a bank are any instruments which are owed to them, such as commercial loans, mortgage loans, etc., while liabilities are what they owe others, like depositor funds, debt issuances or preferred stock issuances. If the bank does not meet the Tier-1 capital ratio under these requirements, they face insolvency and the FDIC will place the bank into receivership. If the ratio is below 4% then they must either sell some assets, almost certainly at a loss, and are usually under a consent order to not make any new loans until they increase the amount of Tier-1 capital to minimum adequate thresholds. Two options exist for increasing the amount of Tier-1 capital: 1) to sell common stock; or 2) to sell perpetual Convertible Preferred Stock. The Dodd-Frank Act has effectively removed Trust Preferred Shares (TruPSs), an previously approved debt/equity hybrid for of preferred securities as an option for all banks, except small bank holding companies $500 million in assets or smaller.

The recently passed Dodd-Frank Act has added further problems for the banks with regard to at least maintaining Tier-1 capital ratios at the current level. The law states that banks will not be able to count TruPSs as Tier-1 capital beginning in 2013. The four largest banks have in excess of $86 billion of TruPSs that will literally disappear as Tier-1 capital in 2013 and will need to be replaced dollar-for-dollar. This figure does not take into account and consider the trillion of dollars of impaired residential loans and real estate owned (REO) on the banks balances sheets that require effective capital retooling and solutions. Additionally, the systemic losses encountered by the top 20 largest deemed to big to fail banks requires an enormous amount of additional capital required above these TruPSs replacements. This large amount of TruPSs will need to be replaced with either perpetual preferred or common stock or discounted asset sales. In the present economic environment, these banks will need to make the financial terms of their stock or debt issuance extremely attractive with discounts in order to attract investor interest for the imputed investment risk. This likely could cause a future stock ‘dumping’ on the markets that will cause the stock prices to drop again across the banking industry closing the loop on a vicious cycle. The financial health of the bigger banks either pull the banking sector up or down depending on the economic environment.

This will occur not only with large banks but with small banks as well. While small banks can still use TruPSs as Tier-1 capital, TruPSs are too expensive for even the small banks to issue and they have no distribution ability of their issuances without being able to piggyback issuance in pools of larger financial institutions. When the Dodd-Frank Act shut down TruPSs issuances for the big banks, it has effectively shut TruPSs issuances down for the small banks as well.

Many small banks have another problem and that is that their common stock, if they are publicly traded, has a small float. If the bank is privately held, there exists an additional set of capital raising issues, in that an investor has to exit strategy to own the private stock and no liquidity accordingly. Many small banks may have thinly publicly traded common stock, however a large percentage of the stock is held by a group of insider shareholders that do not sell these shares. The shares that do trade on a daily basis are called the float and this float is small for many banks, which means that an investor has limited or no exit strategy once he/she makes an investment in a bank or a corporation with a small stock float. The investor is at the mercy of the bank and the market. This makes it even more difficult for anyone buying new shares from the bank to sell these shares into this small float and make a profit even if the shares are bought at discount. The small float essentially means there is diminished market for these shares to the point that there may not be a market replacement investor for the first investor for some time or even at all, if very few of the outstanding shares are being traded currently.

Small banks across this U.S. are with faced a similar dilemma, even if they do not have a small float. Investors do not often invest in companies they know little about. Small banks are known locally, but not regionally and certainly not nationally, even if the bank's stock trades on a national exchange. Small banks have a bland local hometown business model and often cannot use or have access to an innovative invention or technology to entice investors to buy their stock and debt offerings. The present invention provides a solution to this situation.

Thus, in this current banking crisis, the banks need to and are required by law, to raise Tier-1 capital levels not only so they can restart the process of lending and making loans, but to grow and compete so that they can survive. The banks are left with two options to raise their tier capital levels: 1) to sell perpetual Convertible Preferred Stock; or 2) to sell their equity or common stock. The banks are at a virtual standstill because no one wants to invest in these financial sector stocks because the investor does not see any reasonable investment exit strategy and how they will get their investment capital out of the stock investment. If a bank isn't lending and growing it is dying a slow death, a death by a thousand cuts.

Corporations, inclusive of banks, have tried several different solutions to try to sell their stock at market value. Sometimes, but rarely, the method is able to achieve a premium above the market value. There are IPO' s such as “LinkedIn IPO Soars, Feeding Web Boom”, that used technology to boost the stock price. Banks and most other corporations are not able to use this method. Banks and most other corporations have to use warrants and discounts as in “Barclay's capital raising-the real cost of Bob Diamond.” Warrants are a right or an option to buy a stock at specific price, usually less than current market price, for a prescribed period of time into the future, however; this requires a further investment by the investor with no guarantee of repayment of the entire initial investment or the follow-on investment derived from the warrants.

Convertible Preferred Stock, a hybrid form of debt/equity issuance, is another method that a corporation might use, but once again, the investor still has no guarantee that the conversion to common stock will stay at the conversion price long enough for the investor to sell the common shares at that conversion price. If the shares drop, the investor will lose money if the investor is unable to find another investor through a matched trade on an exchange if the bank or corporation has a small float. To make Convertible Preferred Stock work for the investor, which needs to be higher than the return offered on other forms of financial securities, the investor would have to be paid a competitive market dividend based on credit worthiness of the issuer that is higher than on the common stock and also guarantee the common stock price would rise after the investor converted from preferred to common stock. Corporations and banks do pay more dividends to the convertible preferred and these dividends are an extra burden on the issuer's income statement because under the U.S. Internal Revenue Code, dividends are not tax deductible. However, conversely, no one can guarantee that the common stock price will rise after the investor converts common stock or that the stock price will remain the same ‘as issued’. There are transaction costs, such as broker's fees that must be paid whenever common stock is bought or sold. The investor will have to actually see an increase in the stock price in order to breakeven and get full repayment of the initial investment.

3. Objects And Advantages

The main objective of the invention is to:

A) Create a superior Open-offer Securities exchange and distribution platform for issuers and investors of financial securities that can offer an enhanced and superior yield to both qualified and non-qualified secondary market investors without materially altering the issuers cost of capital.

B) Create a superior financial securities exchange that may raise more money for a corporation through a captive market wherein its own debt securities issuances can act as a means of raising capital linked to new stock issuances.

C) Create an innovative security that bundles a wide range of financial securities and financial assets like traditional debt, equity, quasi-equity, CDO's CMO's, etc into an investment unit.

D) Create a security that has the ability to replace and replenish the Tier-1 regulatory capital of a company and provide balance sheet enhancement pursuant to laws and regulation.

E) Create a financial product wherein a company can leverage its existing balance sheet and create additional capital.

F) Create a matched system for buying and selling of financial securities wherein an investor in a private placement primary issue can resell the issuers securities at a premium.

G) Create a capital raising process that results in a minimum amount of stock dilution for existing shareholders and the issuer by eliminating the need to discount the stock in order to sell the stock.

H) Create a process for present value monetization of future cash flows wherein the investor in a certain debt security could reinvest a portion of the monetization to the issuer of the debt security as stock and other financial securities or financial assets.

### SUMMARY OF THE INVENTION

The present invention relates to the creation of an investment process method and system (the “Investment Exchange”) for the issuances and investments of securities of global institutions (including but not limited to; Banks, Insurance Companies, Corporates and Governments) hereinafter called the “First Party Issuer” or the “Issuer”. The Investment Exchange is powered by a proprietary reallocation algorithm that reallocates the cash flows on an issuer's private placement Investment Unit offering.

The investment process works by internally re-generating, redistributing and rebalancing the investment capital with a method of monetizing the income stream wherein the cash flows of the securities comprising the Investment Unit are reallocated, repackaged, matched and hedged in a cash-settled capital raising process.

The Investment Exchange generates a matched supply of capital to reinvest in the Investment Unit and the core of the structure recycles the investment capital by a method of monetizing the future income stream while simultaneously matching and hedging the investment in a customer-driven, matched, cash-settled securities investment transactions and capital raising process with counterparty participants.

The investment process provides a unique opportunity for an issuer to raise as much regulatory and/or non-regulatory capital that it requires, from time-to-time and on an ongoing basis, simultaneously adding long-dated deposit commitments to its balance sheet and with a comparative effective interest cost well below Tier-1 direct issuance cost.

The investment process provides a variety of investment options to its counterparty participants, including means for buying and selling a plurality of securities, including but not limited to; equity, certificates of deposit, medium term notes, preferred securities, debentures, exchange rights, options, derivatives and other forms of secured and unsecured debt and assets, including but not limited to CDO's, CMO's, REO, impaired loans, etc.

The investment process enhances the yield on the debt issuances through a reallocation of internal cash flows within the Investment Unit thus creating an investment arbitrage. The system creates techniques used to improve the marketability of the securities to investors.

### Overview of System

The invention provides a new system and method for trading assets and liabilities online via an Investment Exchange.

An embodiment of the invention provides an Investment Exchange for buying or selling financial securities and financial assets held by First Party Issuer or a Second Party investor (the Primary Investor”), where some of the financial securities are purchased at a discount and then remarketed through an Investment Exchange to qualified and non-qualified secondary market investors at a premium to their purchase price.

The Investment Exchange licenses certain issuers as licensees to a first party (hereinafter called the “First Party Issuer” or the “Issuer”), to offer their financial securities (including but not limited to debt and equity securities, exchange rights, options, derivatives, etc) and financial assets (including but not limited to CDO's, CMO's, REO, impaired loans, etc) for sale on the Investment Exchange. These licensees could include but are not limited to; Banks, Insurance Companies, Corporates and Governments. The Issuer would offer to sell at least two financial securities (including at least one debt and one equity security or an option to purchase one equity security, exchange rights for the debt instrument are sold separately), which are initially embedded as part of an investment unit and is subsequently separated from the investment unit and exchanged with a new financial security (the “Remarketing CD”) that offers superior returns.

In addition, the Investment Exchange has at least one Primary Investor who is the initial investor in the issuances of the First Party Issuer, and a least one third party investor (the “Secondary Investor”) that would purchase the First Party Issuer's debt issuances in a secondary market sale from the Primary Investor. All the participants of the Investment Exchange would have set-up depository accounts with linked bank accounts that would be directly linked to the Investment Exchange to execute the transactions electronically.

The First Party Issuers are pre-qualified and pre-approved and their detailed financial data (e.g. capital call reports in the case of banks) is available electronically on the platform database before they log on to the system to take part in an Offer-Bid-Ask auction system.

The best demonstration for the present invention would be to use a bank as the First Party Issuer in an example. The bank places more weight and needs the undiscounted regulatory Tier-1 capital the most. The Primary Investor will buy the Investment Unit from the First Party Issuer. The Investment Exchange would then strip and exchange the debt security from the Investment Unit, wherein the debt security with the enhanced yield would be offered to the Secondary Investor. Simultaneously, the Primary Investor would invest in the Convertible Preferred Stock of the bank and either hold the Convertible Preferred Stock for the dividend income or try to sell at a profit in an open market transaction to follow-on investors.

Start: The First Party Issuer inputs specific details into the Investment Exchange system relating to maturity, price, yield, discount, type of securities and par amount, etc., of the securities issuances that they wish to offer to sell on the platform. Thereafter, the Investment Exchange automatically reallocates values by extrapolating the input data that has been keyed-in with the Issuer's latest and most current financial data and generates a primary market placement term sheet based upon the reallocated pricing (the reallocation of the pricing results in changes in par values, original issue discount (“OID”), etc.) that could be a fixed or a variable pricing, for a basket of securities all of which are bundled into an Investment Unit. In our example, the Investment Unit comprises of the following: 1) a subordinated, uninsured certificate of deposit called (the “Transition CD”); 2) a forward contract to purchase non-cumulative perpetual Convertible Preferred Stock (the “Convertible Preferred Stock”) that qualifies as Tier-1 capital (the “Forward Contract”). Alternatively, a combination of both the Convertible Preferred Stock and the Remarketing CD could comprise a part of the forward contract. Exchange rights (the “Exchange Rights”) are sold at a nominal cost separately from the Investment Unit. The Investment Unit is structured in such a manner for two reasons; firstly as a financial instrument to reallocate the coupon and cash flows between the securities and derivatives within the Investment Unit based on our proprietary reallocation algorithm and secondly as an effective tax planning tool.

Step-2: The second part of the Transaction involves the Primary Investor making a bid on the Investment Exchange to purchase the Investment Unit. Upon successfully winning a bid, the Primary Investor would execute agreements to make an investment in the Bank's Investment Unit that is customized and issued as per the Investment Exchange's parameters. The Primary Investor is allowed, pursuant to the prescribed Exchange Rights, to exchange the Transition CD for a higher yielding Remarketing CD issued with an Original Issue Discount that will be remarketed through the Investment Exchange network in a secondary market transaction.

In an alternative embodiment, any other form of debt instrument in the universe of debt securities issuances could be used instead of a certificate of deposit (Remarketing CD) and an alternative equity security or financial asset could be used instead of the Convertible Preferred Stock.

Step 3: Subsequent to the acceptance of terms by the Primary Investor, the Investment Exchange creates and markets a secondary market debt placement term sheet for the Remarketing CD that is circulated amongst its Secondary Investors which informs them that there is available for purchase a, e.g. 10-year Remarketing CD that pays 7.5% interest per year (the rate will be higher than an investor could ordinarily receive on a $1,000 security. 7.5% is a demonstration rate and the term of the Remarketing CD could vary from 3 years to 15 years).

Step 4: Upon the Secondary Investor's acceptance of the terms of the Remarketing CD, the Investment Exchange exercises the Forward Contract on behalf of the Primary Investor and separates the $300 Convertible Preferred Stock from the 2-year $700 Transition CD from the Investment Unit. The Investment Exchange then subtracts the Exchange Rights from the account and exchanges the 2-year $700 Transition CD for a new 10-year Remarketing CD that has a present value of $700 corresponding to the money paid for the 2-year $700 Transition CD and a par value of $1,000. The new Remarketing CD has an original issue discount of $300 and pays a 7.5% interest rate per year. The coupon of the Remarketing CD offers an enhanced return predicated upon the risk profiling based reallocation of the cash flows calculated using the proprietary reallocation algorithm. Key characteristics of the Remarketing CD are as follows: 1) Non-callable and purchased with an original issue discount; 2) Offers higher than market returns based on the reallocation of cash flows and the inherent tax shelter provided to the Bank; 3) Fixed (“bullet”) maturity date. Maturities generally range from three years to fifteen years; 4) Remarketing CDs are available in fixed-rate or variable-rate structures; 5) The Remarketing CDs could be either FDIC insured or uninsured Tier-2 compliant, depending on the Bank's requirement for Tier-2 capital.

Step 5: The Secondary Investor purchases the First Party Issuers Remarketing CD from the Primary Investor via the Investment Exchange in a secondary market transaction on the following general terms: a) the Remarketing CD is purchased at a premium over its accreted value enabling the Secondary Investor to receive a higher return in comparison with what a similar investment would get an investor in a direct market purchase from the First Party Issuer; b) each Remarketing CD constitutes a direct obligation of the First Party Issuer and is not, either directly or indirectly, an obligation of the Primary Investor; c) since the Remarketing CD is purchased in the secondary market at a premium over the accreted value, any unamortized premium is neither the obligation of the Bank, nor is it insured. Therefore, if deposit insurance payments become necessary for the Issuer, the Secondary Investor can incur a loss of up to the amount of the unamortized premium; d) any phantom income tax to the Secondary Investor due to the OID on the Remarketing CD, would get neutralized by the secondary market purchase of the Remarketing CD at a premium over the accreted value of the Remarketing CD; and finally, e) upon maturity, the Remarketing CD is redeemed at par value.

Step 6: The Investment Exchange receives $1,000 upon the sale of the Remarketing CD to the Secondary Investor and deposits the $1,000 into the First Party Issuer's account with $700 on account of the Remarketing CD purchase consideration and $300 on account of the convertible preferred stock purchase consideration. The $300 of Convertible Preferred Stock is transferred into the Primary Investor's depository account. The net proceeds the Primary Investor receives from the sale of the Remarketing CD's could be used for its general corporate purposes, including hedging costs apart from the purchase of Convertible Preferred Stock contracted for in the Forward Contract in the Investment Unit. The Primary Investor retains and holds the Convertible Preferred Stock as a long-term investment on its balance sheet. The dividend that the company has to pay on the Convertible Preferred Stock is adjusted through a proprietary reallocation algorithm that is an integral part of the Investment Exchange. The Convertible Preferred Stock has been sold without the First Party Issuer being forced to sell at a discount eliminating dilution issues and the interest coupon on the Remarketing CD is high enough that the company can easily resell the debt instrument to a Secondary Investor through the Investment Exchange. Summarizing, the First Party Issuer: 1) has sold the Convertible Preferred Stock without having to offer a discount; 2) is paying a much lower dividend on the Convertible Preferred Stock than comparable market yields call for; 3) pays a higher interest on the debt instrument that is tax deductible instead of higher dividends; and 4) the original issue discount provides a tax deferment over the life of the debt instrument. The Primary Investor gains ownership of the Convertible Preferred Stock that pays a lower dividend but the entire original investment has been recouped. The Secondary Investor would invest in a Remarketing CD that is paying a higher rate of interest than they would normally receive in the market place.

The steps provided in the present invention give the First Party Issuer, $300 in Tier-1 capital and $700 in Tier-2 capital. The 2% dividend rate on the Convertible Preferred Stock is well below the market rate for investor yield requirements and the dividend does not have to be perpetual. The Convertible Preferred Stock can be convertible immediately and reduce the dividend burden. Note that the bank is guaranteed to receive the full amount for the stock with no discount.

In the present example, the Remarketing CD is uninsured and subordinate and meets the criteria of tier-2 capital; therefore the bank also receives $700 in Tier-2 capital as well. The interest is equal to what the small bank would have had to pay to attract a sophisticated or institutional investor for the $700 in Tier II capital for the measured investment risk. The Reallocation algorithm system works in such a manner that the interest, coupon, dividend and yield get reallocated across the various components of the Investment Unit whilst at the same time maintaining Issuers cash outflow and interest cost. The deductibility of interest paid on the $300 OID portion of the Remarketing CD combined with the 2% dividend on the Convertible Preferred Stock is still less than the dividend market rate for Tier-1 capital, even if the small bank could have found an investor for its Tier-1 securities. The market rate for preferred dividends could have easily been 9%-12% or higher, with no investors interested, even at that higher rate. Many small banks, even if they could have found a willing investor would face enormous cash outflows, which would be a vicious cycle, compound the problem and lastly, the dividend obligation would be perpetual. So the small bank benefits from the interest payments ending in 10-years. The small bank also benefits from the tax deferment of the OID for 10-years.

The steps provided in the present invention also benefit the Secondary Investor. The Secondary Investor is most likely an ordinary account holder of the bank, e.g. savings deposit, money market deposit account (MMDA), and time deposit customers as well as new bank customers and only needs $1,000 to buy the Remarketing CD that pays 7.5%. The customer is able to buy a Remarketing CD issuance of the bank paying higher rate of interest, something usually reserved for institutions willing to invest millions of dollars. This in turn adds a benefit to the bank because the bank can use the higher rate CD to attract more account holders if the bank so chooses and opens the field of investors all the way down to the nonqualified retail investor.

The steps provided in the present invention also benefit the Primary Investor. The Primary Investor is able to receive $300 in Convertible Preferred Stock and have their entire initial $1,000 investment present valued monetized upon the Remarketing CD resale. This gives the Primary Investor an advantage over any other Investor. The other market investors would need to buy the stock and demand a much higher dividend than the Primary Investors using this invention. Any other Primary Investor will be investing money in the stock with no guarantee that the investment will be returned. Stock is a speculative investment with risk and for that risk any other Primary Investor will need more than a low 2% dividend to offset that risk. This invention removes the risk for the Primary Investor who in turn can give the bank a reduced dividend obligation compared to market. This allows the Primary Investor to legitimately undercut even the large Institutional Investors. The banks do need raise capital by selling various forms of stock as an investment, but they will want to pay less in dividends to get that capital.

### BRIEF DESCRIPTION OF THE DRAWINGS

Preferred exemplary embodiments of the present invention are described here with reference to the accompanying drawings, which form a part of this disclosure, and in which like numerals denote like elements.

FIG. 1 is a perspective view of the flow diagram of the “Overview of Investment Exchange” illustrating steps in accordance with an embodiment of the present invention;

FIG. 2 is a perspective view of a flow diagram of the “Transaction Flow” of the present invention;

FIG. 3 is a perspective view of a flow diagram of the “Business Process Flow-Pre-Issuance” of the present invention;

FIG. 4 is a perspective view of a flow diagram of the “Business Process Flow-Reallocation and Pricing” of the present invention.

FIG. 5 is a perspective view of a flow diagram of the “Business Process Flow-Credit Enhancement” of the present invention;

FIG. 6 is a perspective view of a flow diagram of the “Business Process Flow-Order Settlement” of the present invention;

### DETAILED DESCRIPTION OF THE PREFERRED EMBODIMENTS

A method and system is disclosed for the creation of a Cross Settlement, Risk-Mitigation and Netting System (the “System”) for the issuances and investments of securities of global institutions (including but not limited to Banks, Insurance Companies, Corporates and Governments). The Investment Exchange is powered by a proprietary algorithm based settlement engine that matches variable pay-ins and payouts based upon movements in benchmark rates.

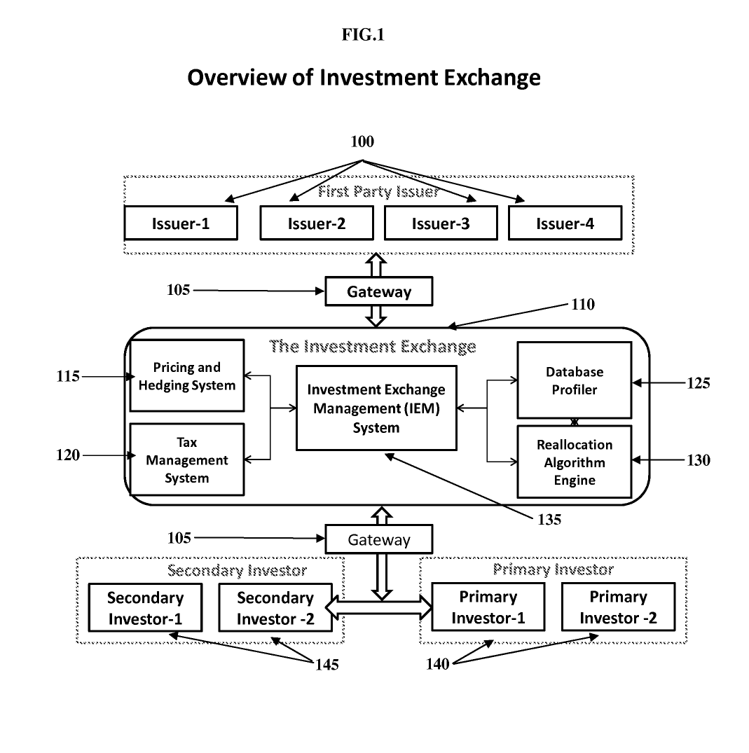

Referring to the illustrative drawing of FIG. 1, there is shown a flow diagram for the “Overview of Investment Exchange”. The Investment Exchange Platform 110 enables participants to instantly issue, credit enhance, securitize, hedge, sell, buy, refinance, any debt or equity security, certificates of deposit, repurchase notes or create credit enhanced and guaranteed financial products through an electronic bid-ask system that allows bids to be submitted by various Issuer Participants for either investments (e.g. the yield-to-maturity desired by an investor or issuer), secured debt (e.g. the interest rate desired by a investor or issuer) or the purchase and remarketing of debt and equity instruments. First Party Issuer 100 registers on to the Investment Exchange 110 to offer its various securities for sale and makes available its current financial database (e.g. FDIC call reports). The First Party Issuer 100 receives a User ID and password to submit an offer and/or a bid and enters the Investment Exchange 110 through a secure and encrypted Gateway 105 that is accessible via the internet. The Primary Investor 140 and the Secondary Investor 145 register on the Investment Exchange 110 with seamlessly linked trading accounts, depository accounts and bank accounts to participate in buying and selling the First Party Issuers' 100 securities. The First Party Issuer 100 simultaneously submits their at least one debt and at least one equity offering and inputs various parameters relating to each security including amount, maturity, ask price into the Investment Exchange 110. The Investment Exchange 110 consists of an Investment Exchange Management System 135, which is comprised of four interconnected systems: (i) the Database Profiler System 125 that matches the First Party Issuers 100 input parameters with the risk and credit profile of the First Party Issuer 100 and provides a risk and credit profile along with a fair market value of the First Party Issuer's 100 securities issuances; (ii) a Reallocation Algorithm Engine 130 that generates a cash flow reallocation based upon the fair market value inputs received from the Database Profiler 125 and extrapolated into the Reallocation Algorithm 130; (iii) a Tax Management System 120 that calculates the tax shelter based upon the reallocation of the cash flows; (iv) a Pricing and Hedging System 115 that allocates the par value and original issue discount amount of securities that can be issued based upon inputs from the Reallocation Algorithm System 130 and the Tax Management System 120. The Investment Exchange Management System 135 collates the data generated by all the sub-systems and generates matching Term Sheets for the First Party Issuer 100, the Primary Investor 140 and the Secondary Investor 145. Upon acceptance of the Term Sheets by all parties, the Investment Exchange Management System 135 generates the Investment Unit 200 and subsequently strips the Transition CD 200a from the Investment Unit 200 and creates the Remarketing CD 200d. To qualify for acceptance by the Primary Investor 140, the bid must contain a positive arbitrage between the First Party Issuer's 100 issuance price and the Primary Investor's 140 resale price to the Secondary Investor 145. This is determined by the Reallocation Algorithm Engine 130. Once logged into the Investment Exchange Management System 135 all First Party Issuer 100 offers are submitted during a pre-determined auction period. The Primary Investor Participants 140 that has been prequalified and received a UserID and password to submit an offer and/or a bid enters the Investment Exchange 110 through Gateway 105. The Investment Exchange Management System 135 prioritizes the offers based upon the parameters established in the Reallocation Algorithm Engine 130. All offers will be strictly confidential and will not be disclosed publicly or to other counterparty Issuer or Investor Participants. Offers will be ranked in order from the greatest to the lowest Spread and selection of winning offers will start with those counterparty participants offering the greatest Spread. All other offers not meeting the system requirements will be rejected.

One embodiment of the invention, as explained in FIG. 1, shows that the Investment Exchange can also be viewed as an electronic exchange that allows Participants (i.e. investors, issuers corporates, governments and banks) to come together to match their requirements in generating, but not limited to, insured and uninsured deposits, preferred capital, principal protected notes, secured loans, investment grade rated investments and other assets.

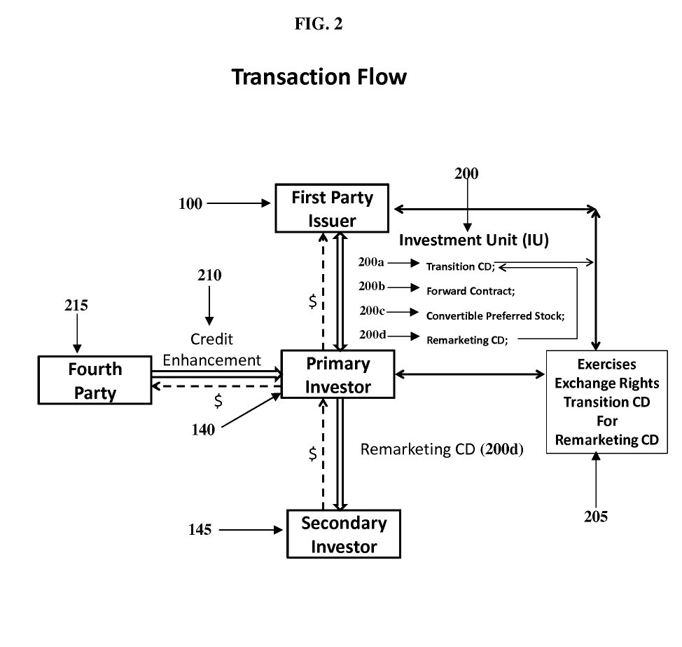

Referring to the illustrative drawing of FIG. 2, there is shown a flow diagram for “Transaction Flow” of the process of the purchase of an investment unit, stripping and exchanging of securities and remarketing of certain securities accessed through the Investment Exchange 110. The First Party Issuer 100 sells an Investment Unit 200 to the Primary Investor 140 via the Investment Exchange 110 said Investment Unit 200 comprising of: 1) a certificate of deposit called (the “Transition CD”) 200a, and; 2) a forward contract (the “Forward Contract”) 200b to purchase non-cumulative convertible perpetual preferred stock (the “Convertible Preferred Stock”) 200c that qualifies as Tier-1 capital. Separately, exchange rights (the “Exchange Rights”) 205 are purchased at a nominal cost to exchange 205 the Transition CD 200a for a higher yielding CD (the “Remarketing CD”) 200d issued with an Original Issue Discount. The IEM System 135 strips the Primary Investor's 140 Transition CD 200a from the Investment Unit 200 and exchanges 205 it with a Remarketing CD 200d. The Primary Investor 140 sells the Remarketing CD 200d to the Secondary Investor 145 via the IEM System 135 and the Primary Investor 140 receives the Remarketing CD 200d purchase consideration. The Primary Investor 140 remits a part or the complete amount of the Investment Unit 200 purchase consideration to the First Party Issuer 100. If the Primary Investor 140 has already remitted the Investment Unit 200 consideration earlier, then the Primary Investor 140 recoups his initial investment. The Primary Investor 140 retains the Convertible Preferred Stock 200c equity component of the Investment Unit 200. Any surplus or difference in the proceeds of the sale of the Remarketing CD 200d versus the initial purchase price of the Investment Unit 200 are reinvested in purchasing Credit Enhancement 210 (comprising of highly rated securities) from a Fourth Party 215 whereby the Remarketing CD 200d receives one hundred percent (100%) principal protection.

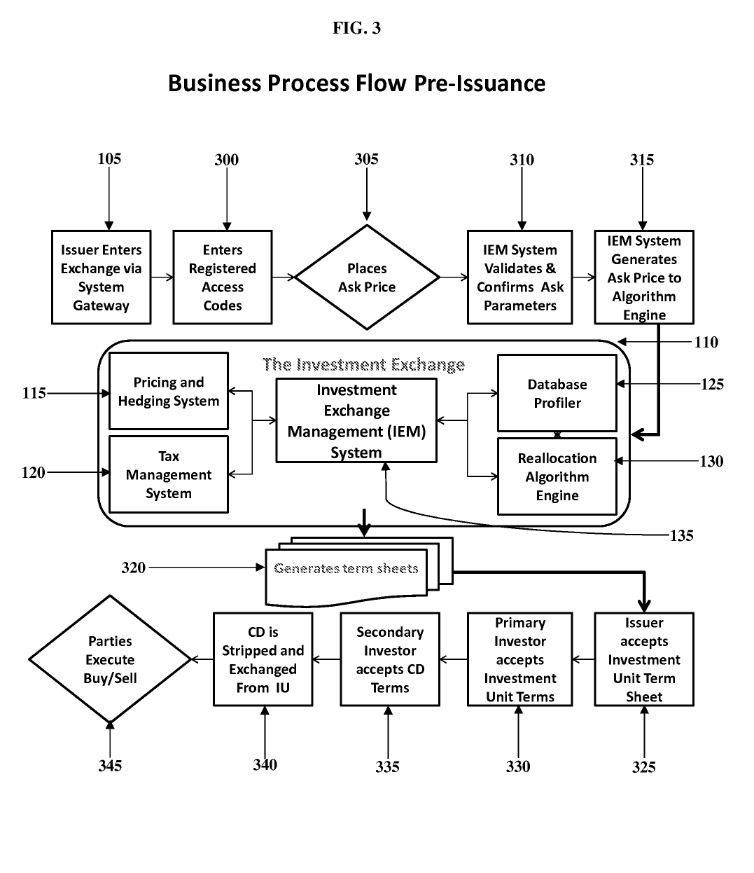

Referring to the illustrative drawing of FIG. 3, there is shown a flow diagram for the “Business Process Flow-Pre-Issuance” of a process of issuing, creating, exchanging, purchasing, remarketing, modifying or confirming bids using the Investment Exchange 110. Participants, First Party Issuer 100, Primary Investor 140, Secondary Investor 145 and Fourth Party 215 access the Investment Exchange 110 via Gateway 105 and enter their respective Registered Access Codes 300 (previously issued User-ID and Password). Security keys are used to authenticate the user. The First Party Issuer 100 enters the Ask Price Parameters 305 and other issuance parameters for at least two securities. The IEM System 135 validates and confirms the Ask Price Parameters 310 and generates Ask Price 305 to Reallocation Algorithm Engine 130 and makes a determination whether to proceed based upon acceptable Ask Price Parameters 305. The IEM System 135 validates and confirms the Ask Price 305 and the Ask Price Parameters 305 are stored in IEM System 135 server Database Profiler 125. If the Ask Price Parameters 305 are in agreement between the First Party Issuer 100 and the Primary Investor 140, the auction proceeds or is modified or canceled. If affirmative, the IEM System 135 moves on and generates the Term Sheets 320 for the purchase of the Investment Unit 200. If the bid parameters of First Party Issuer 100 and Primary Investor 140 do not match, then the system generates a revised Ask Price Offer 315. Upon the Primary Investors 140 acceptance 330 of the First Party Issuers 100 Ask Price 305, the IEM System 135 generates Term Sheets 320 for the debt and equity securities comprising the Investment Unit 200 of the First Party Issuer 100. Once the Primary Investors 140 accept the Investment Units 200 Term Sheet 320 of the First Party Issuer 100, the IEM System 135 generates a second Term Sheet from the Primary Investors 140 to the Secondary Investor 145 for sale of the Remarketing CD 200d purchased by the Primary Investor 140 as part of Investment Unit 200 from the First Party Issuer 100. The Secondary Investor 145 accepts the offer 335 and executes the Remarketing CD 200d Purchase Agreement and places the purchase consideration into a pre-established escrow. The IEM System 135 strips 340 the Transition CD 200a from the Investment Unit 200 and exchanges 205 it for the Remarketing CD 200d and transfers it from the Primary Investor 140 to the Secondary Investor 145. When ready to close auction, the server Database Profile 125 is updated with the Ask Price Parameters 305 as well as to change the Status of the auction. The types of transactions executed by the Investment Exchange 110 include but are not limited to: 1) Buy/Sell of Medium Term Notes, Asset Backed Securities, Guaranteed Notes, Preference Shares, Certificates of Deposit, etc. with Price and Yield; 2) Buy/Sell of Debt Securities with Price and Yield; 3) Reallocation of Yields and coupons; 4) Exchange of Securities; 5) Present Value Monetization of future cash flows; and 6) Generation and Settlement of Commissions and Fees.

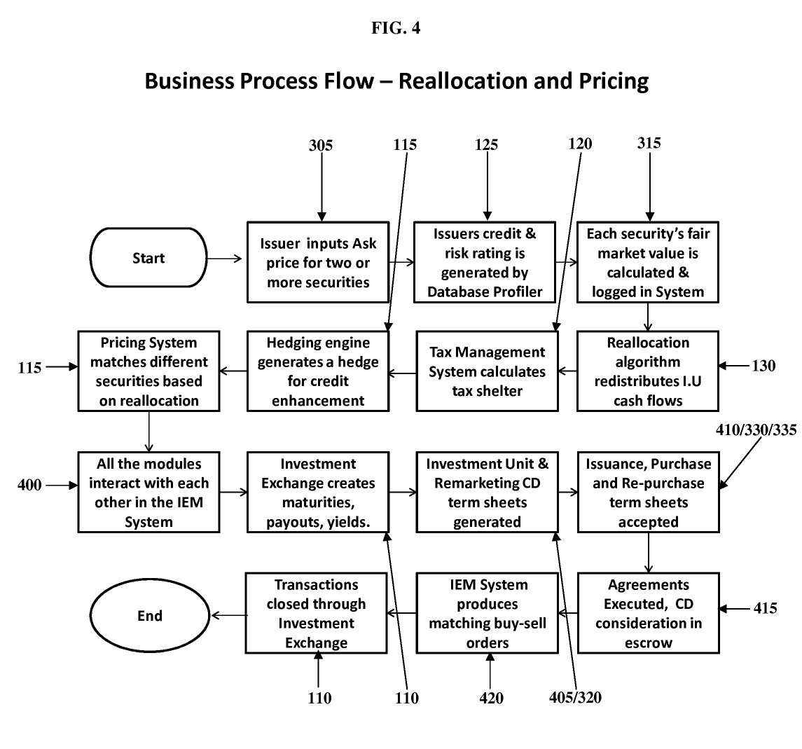

Referring to the illustrative drawing of FIG. 4, there is shown a flow diagram for the “Business Process Flow-Reallocation and Pricing”, which is the process of rebalancing and internally redistributing the cash flows of the securities inside the Investment Unit 200 from one security to the other; debt to equity or equity to debt, and subsequently in real-time generates the final pricing of the respective securities in the Investment Unit 200. First Party Issuer 100 inputs Ask Price Parameters 305 for two or more securities that would comprise an Investment Unit 200. The Ask Price Parameters 305 are compared with the Database Profiler 125 and based upon the First Party Issuers credit and risk rating; it generates the internal Ask Parameters 310 to the Reallocation Algorithm Engine 130. The fair market value of each security comprising the Investment Unit 200 is calculated and logged in IEM System 135. Based on the inputs from the Database Profiler 125, the fair market initial interest and yield pricing parameters of the securities are generated and the Secondary Investors 145 yield enhancements are calculated wherein the Investment Unit 200 cash flows are redistributed by the Reallocation Algorithm 130. The Tax Management System 120 calculates the tax shelter post reallocation and incorporates it as a factor in the final pricing. The Hedging Engine 115 generates a conditional hedge for Credit Enhancement 210 of the insured or uninsured or non-principal protected part of the Remarketing CD 200d. All the modules interact with each other in the IEM System 135. The Pricing System 115 matches the different inputs from the Database Profiler 125, the Reallocation Algorithm Engine 130, the Tax Management System 120, and the Hedging Engine 115. The Investment Exchange 110 generates a final reallocation price for each individual security comprising the Investment Unit 200 and creates individual and unique maturities, discounts, coupons, payouts, yields, etc. The Investment Unit 200 Remarketing CD 200d Term Sheets are generated by the IEM System 320 to the respective parties. The Issuance, the Investment Unit 200 Purchase Term Sheet and the Re-Marketing CD 200e Purchase Term Sheet are accepted by the respective parties. Agreements are Executed 415 and the Secondary Investor 145 places consideration to purchase the Remarketing CD 200d in escrow. The IEM System 135 produces matching buy-sell orders 345. The Transactions are closed through the Investment Exchange 110. Any and all pricing will get updated on the IEM System 135 in real time in the Database Profiler 125 and will drive all the securities pricings thereafter. The IEM System 135 becomes an intelligent and iterative and interactive system hat learns from its own internal pricing and Reallocation Algorithm Engine 130 as well as taking environment inputs from other market forces of demand and supply.

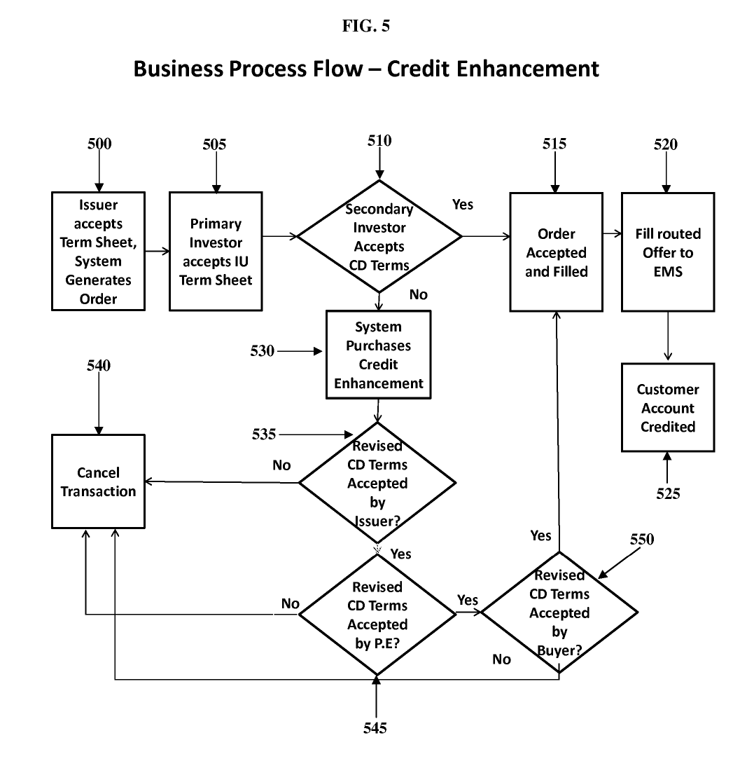

Referring to the illustrative drawing of FIG. 5, there is shown a flow diagram for the “Business Process Flow-Credit Enhancement” process during the auction of creating, modifying and credit enhancing securities with discounts to par value created as a result of market forces or original issue discount using the IEM System 135. The First Party Issuer 100 accepts the Investment Unit 200 Term Sheet and the IEM System 135 Generates Order 500. The Primary Investor 140 accepts Investment Unit 200 Term Sheet. The IEM System 135 Matches the trade counterparties 420, the Primary Investor 140 Accepts 505 Investment Unit 200 Term Sheet. If the Secondary Investor 145 Accepts 510 the Remarketing CD 200d terms, the Order is Accepted and Filled 515 and Routed 520 to the IEM System 135 and upon the payment validation, the Primary Investors 140 Account is debited for payment of the Remarketing CD 200d and payment for the Convertible Preferred Stock 200c and credited 525 with the Convertible Preferred Stock 200c at the same time the Secondary Investors 145 account is debited for payment of the Remarketing CD 200d and credited 525 with the Remarketing CD 200d. The Primary Investor's 140 Account is simultaneously credited with the proceeds of selling the Remarketing CD 200d to the Secondary Investor 145. If the Secondary Investor 145 does not accept the Remarketing CD 200d terms, the Pricing and Hedging System 115 calculates the cost of purchasing Credit Enhancement 210 from a Fourth Party 215 and the IEM System 135 regenerates a revised term sheet (320, 530). The revised Investment Unit terms are communicated back to the First Party Issuer 100 for approval and acceptance. If the revised terms are not accepted by the First Party Issuer (100, 500, 505), the transaction is cancelled 540 and proceeds no further. If the revised term sheet is accepted (325, 535) by the First Party Issuer 100, the revised Investment Unit 200 terms are communicated (330, 545) back to the Primary Investor 140. If the revised term sheet is accepted (330, 545) by the Primary Investor 140, the revised Remarketing CD 200d terms are communicated (335, 550) back to the Secondary Investor 145. If the Secondary Investor Accepts (335, 550) the revised Remarketing CD 200d terms, the transaction proceeds and the Credit Enhancement 210 is bundled into the Remarketing CD 200d and the Order is Accepted 515 and Routed 520 to the IEM System 135 and upon the payment validation, the Primary Investors 140 depository Account is Credited 525 with the Convertible Preferred Stock 200c while the Secondary Investors 145 depository account is Credited 525 with the credit enhanced Remarketing CD 200d, along with respective Participant's accounts debited and/or credit for payment or proceeds from sales. Once an Order 515 has been Routed 520 to the IEM System 135, then the Database Profiler 125 is updated with the latest transaction. Participant's First Party Issuer 100, the Primary Investor 140, the Secondary Investor 145 or the Fourth Party 215 respective Accounts 525 is Credited and/or Debited or both.

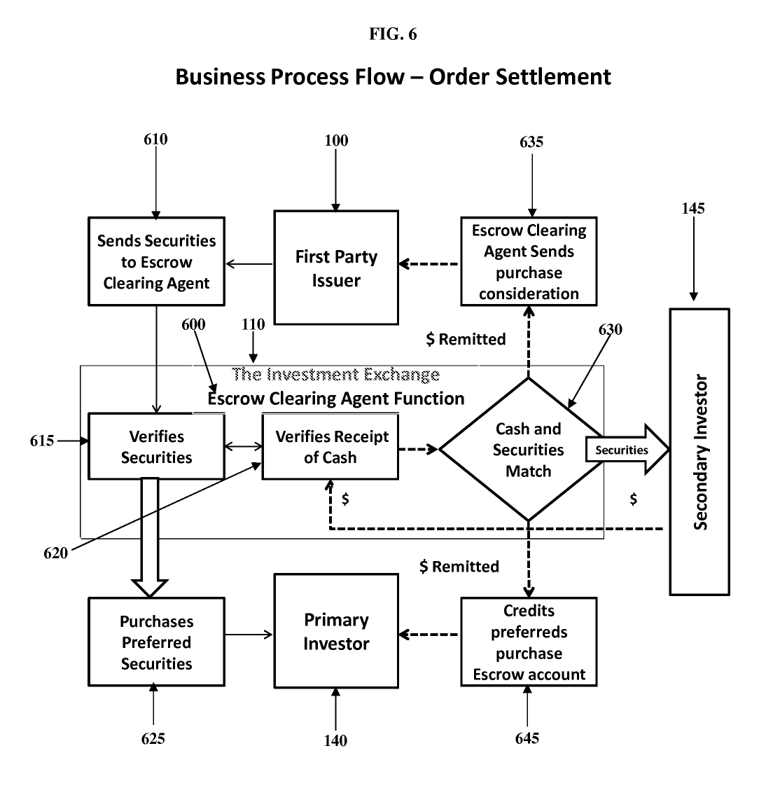

Referring to the illustrative drawing of FIG. 6, there is shown a flow diagram for the “Business Process Flow-Order Settlement” process of settling or closing bids using the IEM System 135 and the Investment Exchange 110 between the matched First Party Issuer Participants 100 with the corresponding Primary Investor Participants 140. The securities purchase agreements that comprise the Investment Unit 200 and the Remarketing CD 200d Agreements are duly executed between the respective parties and the Agreements lodged with the Escrow Clearing Agent (600), which is a component of the Investment Exchange (110). The First Party Issuer (100) issues the Investment Unit 200 and the IEM System 135 sends the Securities 610 to Escrow Clearing Agent 600. The Investment Exchange (110) and the Escrow Clearing Agent 600 Verifies Receipt of Cash 620 and Verifies Securities 615. Cash from the Primary Investor (140) and cash from the Secondary Investor (145) Match to respective Securities being purchased 630. Escrow Clearing Agent 600 Sends purchase consideration 635 for the purchase of the First Party Issuer (100) Investment Unit (200) securities. The Investment Exchange (110) and the Escrow Clearing Agent 600 deliver the Remarketing CD 200d to the Secondary Investor (145) and purchase the Convertible Preferred Stock (200c, 625) on behalf of Primary Investor (140) and Credits preferreds purchase Escrow account 645. The Secondary Investor 145 deposits and delivers purchase consideration for the Investment Unit 200 to Escrow Clearing Agent (600). The Investment Exchange (110) strips the Transition CD 200a from the Investment Unit 200 and exchanges 205 it for the Remarketing CD 205 thereby extinguishing the Transition CD 200a and then the Escrow Clearing Agent (600) delivers the Remarking CD 200e to Primary Investor 140 in exchange 205 for the agreed upon purchase consideration. Contemporaneously with this exchange 205, the Secondary Investor 145 purchases the Remarketing CD 200d from the Primary Investor 140 in a secondary market transaction at its par value. The proceeds from the sale of the Remarketing CD 200d are credited as follows by the Escrow Clearing Agent (600): first the discounted original purchase price of the Remarketing CD 200d is credited for the issuance of the Remarketing CD 200d; second, the balance (i.e. the premium amount on the sale of the Remarketing CD 200d) is allocated for the purchase price of the Convertible Preferred Stock 200c. The Convertible Preferred Stock 200c is delivered to the Primary Investor's 140 depository account upon payment while the Remarketing CD's 200e is delivered to the Secondary Investor's 145 depository account. Alternatively, a part of the premium amount on the sale of the Remarketing CD 200d could be allocated to the Primary Investor 140 for general corporate purposes, for hedging costs or for any other acceptable asset that the First Party Issuer 100 and the Primary Investor 140 agreed upon such sale and purchase.

An embodiment of the invention provides a hedging process wherein, based on a First Party Issuer's credit profile and independent credit evaluation and rating, the Investment Exchange utilizes its Hedging and Pricing Engine to generate a riskless investment hedge in the form of an external credit enhancement against default of an Issuer and subsequently in real-time regenerates the pricing for said yield reallocation and yield enhancement. The Investment Exchange becomes an intelligent, iterative and interactive System that learns from its own internal pricing, reallocation and hedging algorithms as well as taking environment inputs from other market forces of demand and supply.

An embodiment of the invention provides for a forward stock contract and a debt instrument to be sold together in an investment unit and the debt instrument to be resold prior to the forward stock contract being fulfilled. This allows the proceeds and/or profits of the resale of the debt instrument to be used to purchase the stock identified in the forward stock contract. This embodiment does not utilize an exchange of the debt instrument prior to resale.

An embodiment of the invention provides for a forward stock contract and a debt instrument to be sold separately and the debt instrument to be resold through a secondary market transaction remarketing process to third parties by the First Party Issuer as remarketing agent prior to the forward stock contract being fulfilled. This allows the proceeds and/or profits of the resale of the debt instrument to be used to purchase the stock identified in the forward stock contract. This embodiment does not utilize an exchange of the debt instrument prior to resale.

An embodiment of the invention provides for a discount on the conversion formula of the stock based in case of any negative cash flow (net of the enhanced tax shelter) incurred by the bank.

In another operation and use of the invention, debt securities may link up with one or more other Remarketing CDs to create one or more pools of Remarketing CDs (“Pooled Remarketing CDs”) in a new series issue. Remarketing CDs and Pooled Remarketing CDs may link up with one or more other Remarketing CDs and/or Pooled Remarketing CDs to trade.

The present invention has been described in terms of certain preferred embodiments. Those of ordinary skill in the art will appreciate that various modifications might be made to the embodiments described here without varying from the basic teachings of the present invention. Consequently the present invention is not to be limited to the particularly described embodiments.

It should be understood that various alternatives and modifications could be devised by those skilled in the art. The present invention is intended to embrace all such alternatives, modifications and variances that fall within the scope of the appended claims.

It is to be understood that the invention is not to be limited to the exact configuration as illustrated and described herein. Accordingly, all expedient modifications readily attainable by one of ordinary skill in the art from the disclosure set forth herein, or by routine experimentation there from, are deemed to be within the spirit and scope of the invention as defined herein.

What is claimed:

1. A method to sell without a discount the equity or other financial assets and financial securities of a business entity or investment entity by forming an investment unit that includes a division or divisions of financial securities of said business entity or investment entity or a contract to purchase said division or divisions of financial securities of said business entity or investment entity and a debt instrument of said business entity or investment entity, whereby said business entity or investment entity for the purpose of satisfying legal requirements or acquiring investment from possible future investors discloses in writing the specifications and facts of the operation of said investment unit of said business entity or investment entity that includes said division or divisions of financial securities or said contract to purchase said division or divisions of financial securities of said business entity or investment entity and said debt instrument of said business entity or investment entity, whereby an initial investor gives money, rights or property in exchange for a written unconditional promise to pay said sum certain in money on a specified date to said business entity or investment entity, whereby delivering said written unconditional promise to pay said sum certain in money on said specified date to said initial owner of record of said debt instrument of said business entity or investment entity forms said claim on the assets of said business entity or investment entity that may include but is not restricted to land, equipment, buildings, product inventory, office supplies, furniture, cash, financial securities, financial assets, patents, or factories that is equal to said sum certain in money;
identifying said initial investor as any individual, group, or entity other than said business entity or investment entity or any entity owned or controlled by said business entity or investment entity,
delivering by any means to any public media format or to any private placement the written disclosure of the specifications and facts of the operation of said investment unit of said business entity or investment entity that includes said division or divisions of financial securities or said contract to purchase said division or divisions of financial securities of said business entity or investment entity and said debt instrument of said business entity or investment entity as said means of satisfying legal requirements or acquiring investment from possible future investors,
forming the principal of said debt instrument of said business entity or investment entity conveys or issues said written unconditional promise to pay said sum certain in money on said specified date said business entity or investment entity further states in writing that until the said specified date that the principal is to be paid on arrives that interest will be paid and this forms said debt instrument,
entering into any form of understanding or written agreement said business entity or investment entity agrees to sell or trade said debt instrument of said business entity or investment entity and said division or divisions of financial securities of said business entity or investment entity or said contract to purchase said division or divisions of financial securities of said business entity or investment entity together to said initial investor,
receiving money, rights, or property ownership from said initial investor said business entity or investment entity gives to said initial investor said written unconditional promise to pay said sum certain in money on said specified date that forms the principal of said debt instrument of said business entity or investment entity whereby said initial investor becomes said initial owner of record of said debt instrument of said business entity or investment entity,
receiving money, rights, or property ownership from said initial investor said business entity or investment entity gives to said initial investor ownership of said division or divisions of financial securities of said business entity or investment entity or gives to said initial investor ownership of said division or divisions of financial securities of said business entity or investment entity when said contract to purchase said division or divisions of financial securities of said business entity or investment entity is fulfilled whereby said initial investor becomes an initial owner of record of said division or divisions of financial securities of said business entity or investment entity and said initial owner of record of said investment unit of said business entity or investment entity,
delivering said written unconditional promise to pay said sum certain in money on said specified date to said initial owner of record of said debt instrument of said business entity or investment entity in said investment unit of said business entity or investment entity said business entity or investment entity forms said claim on the assets of said business entity or investment entity that may include but is not restricted to land, equipment, buildings, product inventory, office supplies, furniture, cash, financial securities, patents, or factories that is equal to said sum certain in money,
adding to the assets of said business entity or investment entity that may include but is not restricted to land, equipment, buildings, product inventory, office supplies, furniture, cash, financial securities, patents, or factories whereby the assets of said business entity or investment entity that may include but is not restricted to land, equipment, buildings, product inventory, office supplies, furniture, cash, financial securities, or patents are altered,
separating said debt instrument from said division or divisions of financial securities of said business entity or investment entity or said contract to purchase said division or divisions of financial securities of said business entity or investment entity included in said investment unit of said business entity or investment entity after the purchase of said investment unit of said business entity or investment entity by said initial owner of record of said investment unit of said business entity or investment entity is an exercisable right that is included in the specifications and facts of the operation of said investment unit of said business entity or investment entity,

2. A method to sell without a discount the equity of a business entity or investment entity by forming an investment unit that includes a division or divisions of equity that pays a dividend of said business entity or investment entity and a debt instrument of said business entity or investment entity, whereby said business entity or investment entity for the purpose of satisfying legal requirements or acquiring investment from possible future investors discloses in writing the specifications and facts of the operation of said investment unit of said business entity or investment entity that includes said division or divisions of equity that pays said dividend and said debt instrument of said business entity or investment entity, whereby said initial investor gives money, rights or property in exchange for a written unconditional promise to pay said sum certain in money on a specified date to said business entity or investment entity, whereby said business entity or investment entity uses a computer and an algorithm for calculating the reallocation of said dividend of said division or divisions of equity that pays said dividend of said business entity or investment entity to interest that is paid by said debt instrument of said business entity or investment entity;
identifying said initial investor as any individual, group, or entity other than said business entity or investment entity or any entity owned or controlled by said business entity or investment entity,
delivering by any means to any public media format or to any private placement the written disclosure of the specifications and facts of the operation of said investment unit of said business entity or investment entity that includes said division or divisions of equity that pays said dividend of said business entity or investment entity and said debt instrument of said business entity or investment entity as a means of satisfying legal requirements or acquiring investment from possible future investors,
forming the principal of said debt instrument of said business entity or investment entity conveys or issues said written unconditional promise to pay said sum certain in money on said specified date said business entity or investment entity further states in writing that until the said specified date that the principal is to be paid on arrives that interest will be paid and this forms said debt instrument,
entering into any form of understanding or written agreement said business entity or investment entity agrees to sell or trade said debt instrument of said business entity or investment entity and said division or divisions of equity that pays said dividend of said business entity or investment entity together to said initial investor receiving money, rights, or property ownership from said initial investor said business entity or investment entity gives to said initial investor said written unconditional promise to pay said sum certain in money on said specified date that forms the principal of said debt instrument of said business entity or investment entity whereby said initial investor becomes said initial owner of record of said debt instrument of said business entity or investment entity,
receiving money, rights, or property ownership from said initial investor said business entity or investment entity gives to said initial investor ownership of said division or divisions of equity that pays said dividend of said business entity or investment entity whereby said initial investor becomes an initial owner of record of said division or divisions of equity of said business entity and said initial owner of record of said investment unit of said business entity or investment entity,
delivering said written unconditional promise to pay said sum certain in money on said specified date to said initial owner of record of said debt instrument of said business entity or investment entity in said investment unit of said business entity or investment entity said business entity or investment entity forms said claim on the assets of said business entity or investment entity that may include but is not restricted to land, equipment, buildings, product inventory, office supplies, furniture, cash, financial securities, patents, or factories that is equal to said sum certain in money,
calculating means for reallocating said dividend of said division or divisions of equity that pays said dividend of said business entity or investment entity to interest that is paid by said debt instrument of said business entity or investment entity comprising said computer and said algorithm,
adding to the assets of said business entity or investment entity that may include but is not restricted to land, equipment, buildings, product inventory, office supplies, furniture, cash, financial securities, financial assets, patents, or factories whereby the assets of said business entity or investment entity that may include but is not restricted to land, equipment, buildings, product inventory, office supplies, furniture, cash, financial securities, financial assets, or patents are altered,
separating said debt instrument from said division or divisions of equity that pays said dividend of said business entity or investment entity included in said investment unit of said business entity or investment entity after the purchase of said investment unit of said business entity or investment entity by said initial owner of record of said investment unit of said business entity or investment entity is an exercisable right that is included in the specifications and facts of the operation of said investment unit of said business entity or investment entity,
selling or trading either said division or divisions of equity that pays said dividend or said debt instrument included in said investment unit of said business entity or investment entity separate after the purchase of said investment unit by the initial owner of record of said investment unit of said business entity or investment entity is an exercisable right that is included in the specifications and facts of the operation of said investment unit of said business entity or investment entity,
distributing from the assets of said business entity or investment entity cash or other property that is equal to the value of the interest of said debt instrument of said business entity or investment entity to the owner of record of said debt instrument of said business entity whereby the assets of said business entity or investment entity that may include but is not restricted to land, equipment, buildings, product inventory, office supplies, furniture, cash, financial securities, or patents are altered.

3. A method that comprises an investment exchange that is powered by a proprietary reallocation algorithm that reallocates the cash flows on a bank issuer's private placement or registered security investment unit offerings with the investment process that operates by internally re-generating, redistributing and rebalancing the investment capital with a means of monetizing the income stream by reallocating the cash flows of the securities purchased in the investment unit, and repackaging, matching and hedging the investment in a cash-settled capital raising process, wherein a primary investor forming an electronic investment exchange where the at least one first party issuer, said primary investor and at least one secondary investor participate in said electronic investment exchange;
utilizing said electronic investment exchange enabling the participants to instantly enter into agreements, issue, credit enhance, securitize, hedge, sell, buy, refinance, receiving money, rights, or property ownership for any debt or equity security, certificates of deposit, repurchase notes or create credit enhanced and guaranteed financial products through said electronic investment exchange that allows bids and asks to be submitted by various participants including said at least one first party issuer, said primary investor and said at least one secondary investor,
issuing through said electronic investment exchange by said at least one first party issuer an investment unit that comprises of at least one debt instrument that includes the universe of varieties and forms of debt instrument securities and at least one equity security issued by said at least one first party issuer to said primary investor,
separating and exchanging by said primary investor said at least one debt instrument issued by said at least one first party issuer for another debt instrument issued with an original issue discount,
purchasing a division or divisions of said another debt instrument issued with said original issue discount at a premium to its accreted value by said at least one secondary investor, whereby said another debt instrument issued with said original discount providing a higher yield return to the secondary investor due to the yield enhancement performed by the reallocation algorithm of the investment exchange,
receiving money, rights, or property ownership from said at least one secondary investor said primary investor exchanges in return for said another debt instrument issued with said original issue discount.

4. The method according to claim 3, wherein the interest and dividend coupon cash flows are reallocated and matched within the investment unit after incorporating the enhanced tax shelter.

5. The method according to claim 3, wherein the interest and dividend coupon cash flows are reallocated and matched within the investment unit after incorporating the enhanced tax shelter and deducting the net negative cash flow if any, from the conversion formula of the convertible equity.

6. The method according to claim 3, wherein the term of the securities and assets comprising the investment unit could be matched or mismatched.

7. The method according to claim 3, wherein a debt security is purchased with an original issue discount and a part of the discount is invested in highly rated bonds or other forms of credit protection (such as but not limited to a CDS, financial guarantee, etc) such that the credit risk on account of the original issue discount is fully hedged and the principal is at all times fully protected.

8. The method according to claim 3, wherein as the original issue discount on a debt security accretes, the amount required to be invested in credit protection decreases.

9. The method according to claim 3, wherein the at-market price of a financial security issued with an original issue discount to its par value but with an above market coupon that is greater than and at least equal to the par value of the financial security and; the at-market price of a financial security sold at a premium but with a below market coupon is lesser than or equal to the par value of the financial security.

10. The method according to claim 3, wherein a part or complete amount of the net proceeds on the sale of a financial security is reinvested in a benchmark (such as a single stock or a stock linked index) and is thereafter embedded in the financial security such that upon maturity, if the value of the benchmark increases, so does the value of the financial security and if the index decreases, the value of the financial security also decreases.

11. The method according to claim 3, wherein a part or complete amount of the net proceeds on the sale of a financial security is reinvested in a benchmark (such as a single stock or a stock linked index) and is thereafter embedded in the financial security such that upon maturity, if the value of the benchmark increases, so does the value of the financial security and if the index decreases, the value of the financial security stays constant.
